(19) United States
(12) Patent Application Publication
(10) Pub. No.: US 2024/0161390 A1
(43) Pub. Date: May 16, 2024

(54) METHOD, APPARATUS, ELECTRONIC DEVICE AND STORAGE MEDIUM FOR CONTROL BASED ON EXTENDED REALITY

(71) Applicant: Beijing Zitiao Network Technology Co., Ltd., Beijing (CN)

(72) Inventor: Lin CHENG, Beijing (CN)

(21) Appl. No.: 18/507,306

(22) Filed: Nov. 13, 2023

(30) Foreign Application Priority Data
Nov. 14, 2022 (CN) 202211425822.5

(51) Int. Cl. G06T 15/50; G06T 19/00

(52) U.S. Cl. CPC G06T 15/50; G06T 19/006

(57) ABSTRACT

Embodiments of the disclosure provide a method, apparatus, electronic device, and storage medium for control based on extended reality. The control method based on extended reality includes: obtaining a real environment image and spatial positional relationship of the real environment, obtaining a real environment image and a spatial positional relationship of a real environment, and mapping the real environment to an extended reality space based on the real environment image and the spatial positional relationship; setting a virtual light source in the extended reality space; and rendering a light effect for the real environment mapped to the extended reality space based on a light source parameter of the virtual light source, and displaying the rendered extended reality space. Embodiments of the present disclosure can realize personalized environmental lighting display for users.

### CROSS-REFERENCE TO RELATED APPLICATIONS

The present application claims priority to Chinese Patent Application No. 202211425822.5, filed on Nov. 14, 2022 and entitled “Method, apparatus, electronic device and storage medium for control based on extended reality”, the entirety of which is incorporated herein by reference.

### FIELD

Embodiments of the present disclosure relate to the field of computer technology, and more particularly, to a method, apparatus, electronic device and storage medium for control based on extended reality.

### BACKGROUND

Extended reality technology includes virtual reality, augmented reality, mixed reality and other technologies. In the extended reality space, virtual items can be displayed, and the combination of virtual and real items can be displayed to improve the user experience.

### SUMMARY

The present disclosure provides a method, apparatus, electronic device, and storage medium for control based on extended reality.

This disclosure adopts the following solutions.

In some embodiments, the present disclosure provides a control method based on extended reality, comprising: obtaining a real environment image and a spatial positional relationship of a real environment, and mapping the real environment to an extended reality space based on the real environment image and the spatial positional relationship; setting a virtual light source in the extended reality space; and rendering a light effect for the real environment mapped to the extended reality space based on a light source parameter of the virtual light source, and displaying the rendered extended reality space.

In some embodiments, the present disclosure provides a control apparatus based on extended reality, comprising: an obtaining unit configured to obtain a real environment image and a spatial positional relationship of a real environment; a processing unit configured to map the real environment to an extended reality space based on the real environment image and the spatial positional relationship; the processing unit is further configured to set a virtual light source in the extended reality space; the processing unit is further configured to render a light effect for the real environment mapped to the extended reality space based on a light source parameter of the virtual light source; and a display unit configured to display the rendered extended reality space.

In some embodiments, the present disclosure provides an electronic device comprising: at least one memory and at least one processor. The memory is configured to store program code, and the processor is configured to call the program code stored in the memory to execute the above method.

In some embodiments, the present disclosure provides a computer-readable storage medium, the computer-readable storage medium for storing program code, the program code, when executed by a processor, causes the processor to perform the method described above.

In some embodiments, the present disclosure provides a computer program product, the computer program product comprising instructions that, when executed by a computer device causes the computer device to perform the method according to any one of embodiments of the present disclosure.

Embodiments of the present disclosure provides a control method based on extended reality, by mapping the real environment to the extended reality space, the virtual light source is provided in the extended reality space to achieve rendering of the real environment under different lighting, thereby providing user-personalized display of lighting environment.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that elements and elements are not necessarily drawn to scale.

FIG. 1 is a schematic of a device using extended reality according to embodiment of the present disclosure.

FIG. 2 is a flowchart of a control method based on extended reality according to embodiments of the present disclosure is.

FIG. 3 is a schematic of an electronic device according to embodiments of the present disclosure.

### DETAILED DESCRIPTION

The following will describe embodiments of the present disclosure in more detail with reference to the accompanying drawings. Although certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of protection of the present disclosure.

It should be understood that the various steps described in the method implementation method of this disclosure can be executed in parallel. In addition, the method implementation method can include additional steps and/or omit the steps shown. The scope of this disclosure is not limited in this regard.

The term “including” and its variations used in this article are open-ended, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, and are not used to limit the order or interdependence of the functions performed by these devices, modules, or units.

It should be noted that the modification of “one” mentioned in this disclosure is illustrative and not restrictive. Those skilled in the art should understand it as “one or more” unless otherwise specified in the context.

The names of the messages or information exchanged between multiple devices in this public implementation are for illustrative purposes only and are not intended to limit the scope of these messages or information.

The following embodiments of the present disclosure will be described in detail in conjunction with the accompanying drawings.

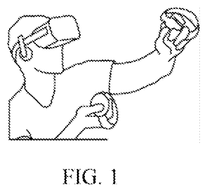

Extended reality can be at least one of virtual reality, augmented reality, or mixed reality. Taking extended reality as an example of virtual reality, as shown in FIG. 1, users can enter the virtual reality space through intelligent end point devices such as head-mounted VR eyes, and control their avatar to interact socially, entertain, learn, work remotely with other virtual characters controlled by users in the virtual reality space.

The virtual reality space may be a simulation environment of the real world, may be semi-simulated semi-fictional virtual scene, may also be a purely fictional virtual scene. Virtual scene may be a two-dimensional virtual scene, 2.5-dimensional virtual scene or any one of three-dimensional virtual scene, the present application embodiment is not limited to the dimensions of the virtual scene. For example, the virtual scene may include the sky, land, ocean, etc., the land may include environmental elements such as deserts and cities, the user can control the virtual object to move in the virtual scene.

In one embodiment, in the virtual reality space, the user can realize the relevant interactive operation by operating the device, the operating device may be a handle. For example, the user performs the relevant operation control by operating the keys of the handle. Of course, in another embodiment, the controller may not be used using gestures or voice or Multi-modal Machine Learning control mode to control the target object in the virtual reality device.

In some embodiments of the present disclosure, the proposed control method may be used for a virtual reality device, a virtual reality device is an end point to achieve virtual reality effects, typically may be provided as an eye, a helmet-mounted display (Head Mount Display, HMD), contact eye form, for achieving visual perception and other forms of perception, of course, the form of virtual reality device is not limited thereto, may be further miniaturized or large as needed.

Embodiments of the present disclosure virtual reality device may include, but are not limited to the following types:

Computer-side virtual reality (PCVR) devices use the PC to perform relevant calculations and data output of virtual reality functions. External computer-side virtual reality devices use the data output from the PC to achieve virtual reality effects.

The mobile virtual reality device supports setting a mobile end point (such as a smart phone) in various ways (such as a Head Mounted Display with a dedicated card slot), and performs virtual reality functions by connecting with the mobile end point in a wired or wireless manner. Relevant calculations, and output data to the mobile virtual reality device, such as watching virtual reality videos through the APP of the mobile end point.

The All in One virtual reality device has a processor for performing virtual functions, so it has independent virtual reality input and output functions, and does not need to be connected to the PC or mobile end point, with high freedom of use.

In order to better understand this disclosure, some of the terms involved in this disclosure are introduced:

Video Perspective (VST): Currently, when using mainstream XR (extended reality) devices (including VR, AR, or MR), users can directly or indirectly view the real scene through the glasses on the device. AR devices usually can directly see the outside world, while VR devices, with the development of color see-through technology, can use RGB cameras to perform anti-distortion processing on captured images to generate real scene images projected onto eye displays.

See Through technology: See through technology is divided into optical perspective technology and video perspective technology. Optical perspective uses optical lenses to directly see the outside world. Video perspective captures a real-time view of the surrounding environment from the camera, processes the captured image through anti-distortion algorithm processing, and then outputs the simulated perspective view of the outside world on the head-mounted display. This technology allows non-optical perspective devices to simulate the real environment one-to-one. Compared with optical perspective, which directly sees the outside world, video perspective uses algorithms to generate and simulate perspective images, so it can be combined with other image processing technologies to replace the content in perspective images.

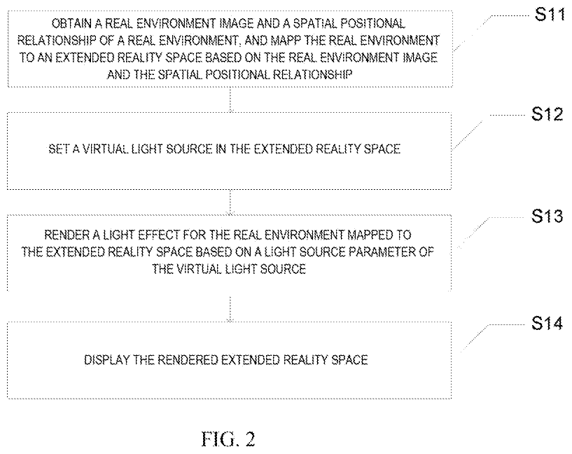

FIG. 2 is a flowchart of a control method based on extended reality according to embodiments of the present disclosure is. The method comprises the following steps.

S11, obtain a real environment image and a spatial positional relationship of a real environment, and map the real environment to an extended reality space based on the real environment image and the spatial positional relationship.

In some embodiments, the method can be used for extended reality devices, such as VR (Virtual Reality) devices or AR (Augmented Reality) devices. Real environment images can be captured by the image obtaining unit on the extended reality device, such as a camera on the extended reality device. In other embodiments, the real environment images can be obtained through see-through technology (which can use optical or video perspective) and transmitted to the processing unit of the extended reality device for processing. The real environment can include environmental scenes and environmental objects. The environmental scene can be a region, and the environmental objects can be people or objects located in the region. The spatial positional relationship includes, e.g., the spatial positional relationship of the environmental scene where the user is located and the spatial positional relationship of the environmental objects in the environment, such as the shape structure of the environmental scene, the position of the environmental objects in the environmental scene. In an example where the user is indoor, the spatial positional relationship can be used to describe the shape of the indoor room and the placement position of items in the room. That is, the spatial positional relationship is used to describe the environmental structure and the position of objects in the environment. The objects here include persons or items. The spatial positional relationship can be obtained through a positioning unit, which may include a visual slam unit, an inertial measurement unit, a laser ranging unit, etc. After obtaining the image of the real environment and the spatial positional relationship, a two-dimensional or three-dimensional model corresponding to the real environment can be generated in the extended reality device to display the real environment in the extended reality space, comprising displaying the surrounding layout, objects, and characters of the real environment. This realizes the mapping of the real environment to the extended reality space, and users can see the real environment when using the extended reality device. Specifically, the real environment can be mapped to the coordinate system of the extended reality space for display.

S12, set a virtual light source in the extended reality space.

In some embodiments, the virtual light source is virtual, which is a virtual light source generated by the extended reality device and has a corresponding light source parameter(s) for the virtual light source. The light source parameters include one or more of the followings of the virtual light source: the light source position, light source angle, light source intensity, hue, focal length, softness, and shading degree. The light source parameters can use the default parameters of the extended reality device. For example, the extended reality device can provide some existing virtual light source models and use the existing light source parameters by selecting the existing virtual light source models. In other embodiments, a user can customize the light source parameters of the virtual light source according to his/her needs. For the virtual light source in the extended reality space, it is used to emit light in the extended reality space.

S13, render a light effect for the real environment mapped to the extended reality space based on a light source parameter of the virtual light source.

S14, display the rendered extended reality space.

In some embodiments, for the virtual light source in the extended reality space, which emits light in the extended reality space, these light rays in the extended reality space are irradiated on the real environment mapped to the extended reality space, which will change the mapping to the extended reality space. In this way, the user can set the virtual light source according to the requirements to view the lighting situations of the real environment under different lighting.

In some embodiments of the present disclosure, in the extended reality space, by mapping the real environment to the extended reality space, a virtual light source(s) is provided in the extended reality space to achieve rendering of the real environment under different lighting conditions, thereby providing personalized lighting for the user.

For example, considering an example where the real environment is an indoor environment, there are rooms and furniture in the real environment. By obtaining images of the rooms and furniture and their spatial positional relationships, the furniture is mapped to the extended reality space. The room and furniture in the extended reality space are displayed, and their layout is consistent with the real environment. Then, virtual light sources are set in the extended reality space, and users can customize virtual light sources so that they can view the room under different light sources in the extended reality space. In this way, users can determine the satisfactory light source according to their preferences, and then purchase a real light source with the same or similar parameters as the virtual light source in the real environment.

In some embodiments of the present disclosure, before the rendering a light effect for the real environment mapped to the extended reality space based on a light source parameter of the virtual light source, the method further comprises: obtaining morphological data of an environmental object in the real environment, initial lighting for environment, and/or initial lighting for environmental object. The mapping the real environment to an extended reality space based on the spatial positional relationship comprises: mapping the real environment to the extended reality space based on one or more of the spatial positional relationship, the morphological data of the environmental object in the real environment, the initial lighting for environment, or the initial lighting for environmental object.

In some embodiments, the morphological data of environmental objects in the real environment can be obtained by techniques such as point cloud. The environmental objects are persons or items in the real environment, and the morphological data is used to describe the three-dimensional shape of the environmental objects. The initial lighting for environment and the initial lighting for environmental objects can be obtained by photosensitive elements, including, but not limited to, hue, lighting intensity, brightness, etc. The initial lighting for environment and the initial lighting for environmental objects can refer to the lighting data of the current environment. With the morphological data of the environmental objects, the initial lighting for environment and the initial lighting for environmental objects, the real environment can be more realistically mapped to the extended reality space, so that the real environment displayed in the extended reality space is closer to its real situation. When the user wears and removes the extended reality device, the real environments he/she sees is almost the same, and there will be no discomfort caused by overly obvious differences.

In some embodiments of the present disclosure, after the mapping the real environment to an extended reality space based on the real environment image and the spatial positional relationship and before the rendering a light effect for the real environment mapped to the extended reality space based on a light source parameter of the virtual light source, the method further comprises: calibrating an optical property of an environmental object mapped to the extended reality space. The rendering a light effect for the real environment mapped to the extended reality space based on a light source parameter of the virtual light source comprises: rendering the light effect for the real environment mapped to the extended reality space based on the light source parameter and the optical property of the environmental object.

In some embodiments, one or more optical properties of the environment object can be manually calibrated by the user, or the material of the environment object can be automatically recognized by the extended reality device and its corresponding optical data can be searched. The optical properties may include, e.g., the reflectivity of the environment object. The optical properties of different environment objects are different. Therefore when the virtual light source shines on different environment objects in the extended reality space, their display conditions are different. By setting the optical properties for the environment object, the rendering of the real environment mapped to the extended reality space is more realistic.

In some embodiments of the present disclosure, the rendering a light effect for the real environment mapped to the extended reality space based on a light source parameter of the virtual light source comprises: rendering a light effect for the real environment mapped to the extended reality space based on a light source parameter of the virtual light source and reference data. The reference data comprises: one or more of: a spatial dimension of the real environment, a positional relationship of environmental objects in the real environment, a material of an environmental object in the real environment, or a user posture.

In some embodiments, when rendering the light effect of the real environment mapped to the extended reality space, reference data needs to be considered, which will affect the rendering effect. For example, the larger the spatial size of the real environment, the smaller the reflection effect of the wall; the smaller the spatial size, and the more obvious the reflection effect of the wall. The positional relationship of environmental objects in the real environment will affect the brightness of the shadow surface, and the material of environmental objects in the real environment will also affect the reflection effect. The user's posture includes, for example, the user's position angle. It is to be understood that observing the image in the extended reality space from different angles may affect the display effect. In embodiments of the present disclosure, the influence of various types of parameters on the light effect rendering is considered to ensure the rendering effect.

In some embodiments of the present disclosure, before the rendering a light effect for the real environment mapped to the extended reality space based on a light source parameter of the virtual light source, the method further comprises: setting a virtual reflective object in the extended reality space. The rendering a light effect for the real environment mapped to the extended reality space based on a light source parameter of the virtual light source comprises: determining a reflection of the reflective object based on an optical property of the reflective object; and rendering the real environment image mapped to the extended reality space based on the virtual light source and the reflection of the reflective object.

In some embodiments, providing a virtual light source can be achieved to simulate the effect of the real environment under different lighting. In practice, there are scenes where a reflective object such as a reflector is used. For example, a user may want to simulate the use of a reflector in a studio situation. At this point, good simulation is difficult by only using the virtual light source. In embodiments of the present disclosure, considering the above-described scene using a reflective object, by setting a virtual reflective object in the extended reality space, it is possible to simulate the shooting effect in the studio and other scenes. The user does not need to set the reflector and other reflective objects in the real world and can still get the display effect after setting the reflective object in the real environment, thereby reducing costs and improving efficiency.

In some embodiments of the present disclosure, the real environment comprises a photographic scene and a photographic object, and the virtual light source comprises a lighting source for the photographic object. The method proposed in embodiments of the present disclosure can be used for virtual photography or photography assistance. By mapping the photographic scene and photographic object (item or person) in the real environment to the extended reality world, and using the virtual light source for lighting, the user can view the final effect without lighting in the real world.

In some embodiments of the present disclosure, the real environment comprises artwork, and the virtual light source comprises a light source of the artwork. Artistic creation can be done by displaying real world art (such as painting) in the extended reality world and providing a virtual light source to achieve the combination of real and unreal.

In some embodiments of the present disclosure, the real environment comprises furniture, and the virtual light source comprises a lamp. In such embodiments, the method proposed in the present disclosure can be used for furniture merchants or users. For merchants, it can provide views of furniture with virtual light sources under different illuminations. For users, the effect of different lighting can be simulated when purchasing new furniture, so as to facilitate their selection.

In some embodiments of the present disclosure, the real environment comprises a real game scene, and the virtual light source comprises a virtual lighting prop. In some embodiments, the method proposed in the present disclosure may be used in a game scene, the user performs a game in a real environment, and the virtual light sources are used as virtual props in the game, thereby increasing the gameplay.

Some embodiments of the present disclosure also propose a control apparatus based on extended reality, comprising: an obtaining unit configured to obtain a real environment image and a spatial positional relationship of a real environment; a processing unit configured to map the real environment to an extended reality space based on the real environment image and the spatial positional relationship; the processing unit is further configured to set a virtual light source in the extended reality space; the processing unit is further configured to render a light effect for the real environment mapped to the extended reality space based on a light source parameter of the virtual light source; and a display unit configured to display the rendered extended reality space.

In some embodiments, before the rendering a light effect for the real environment mapped to the extended reality space based on a light source parameter of the virtual light source, the obtaining unit is further configured to obtain morphological data of an environmental object in the real environment, initial lighting for environment, and/or initial lighting for environmental object. Mapping the real environment to the extended reality space based on spatial positional relationships, including mapping the real environment to the extended reality space based on one or more of spatial positional relationships, morphological data of environmental objects in the real environment, initial lighting for environment, and initial lighting of environmental objects.

In some embodiments, after the mapping the real environment to an extended reality space based on the real environment image and the spatial positional relationship and before the rendering a light effect for the real environment mapped to the extended reality space based on a light source parameter of the virtual light source, the processing unit is further configured to calibrate an optical property of an environmental object mapped to the extended reality space. The rendering a light effect for the real environment mapped to the extended reality space based on a light source parameter of the virtual light source comprises: rendering the light effect for the real environment mapped to the extended reality space based on the light source parameter and the optical property of the environmental object.

In some embodiments, the rendering a light effect for the real environment mapped to the extended reality space based on a light source parameter of the virtual light source comprises: rendering a light effect for the real environment mapped to the extended reality space based on a light source parameter of the virtual light source and reference data. The reference data comprises one or more of: a spatial dimension of the real environment, a positional relationship of environmental objects in the real environment, a material of an environmental object in the real environment, or a user posture.

In some embodiments, the light source parameter comprises one or more of the followings of the virtual light source: a light source position, a light source angle, a light source intensity, a hue, a focal length, a softness, and a shading degree.

In some embodiments, before the rendering a light effect for the real environment mapped to the extended reality space based on a light source parameter of the virtual light source, the processing unit is further configured to set a virtual reflective object in the extended reality space. The rendering a light effect for the real environment mapped to the extended reality space based on a light source parameter of the virtual light source comprises: determining a reflection of the reflective object based on an optical property of the reflective object; and rendering the real environment image mapped to the extended reality space based on the virtual light source and the reflection of the reflective object.

In some embodiments, the real environment comprises a photographic scene and a photographic object, and the virtual light source comprises a lighting source for the photographic object. Alternatively, the real environment comprises artwork, and the virtual light source comprises a light source of the artwork. Alternatively, the real environment comprises furniture, and the virtual light source comprises a lamp. Alternatively, the real environment comprises a real game scene, and the virtual light source comprises a virtual lighting prop.

For the embodiments of the apparatus, since they are basically corresponding to the method embodiments, the relevant parts can be referred to the partial description of the method embodiments. The device embodiment described above is only illustrative, and the modules described as separate modules may or may not be separate. Some or all of the modules can be selected according to actual needs to achieve the purpose of this embodiment. Ordinary skilled persons in the art can understand and implement it without creative labor.

Above, based on embodiments and application examples described method and apparatus of the present disclosure. In addition, the present disclosure also provides an electronic device and a computer-readable storage medium, the following description of these electronic devices and computer-readable storage medium.

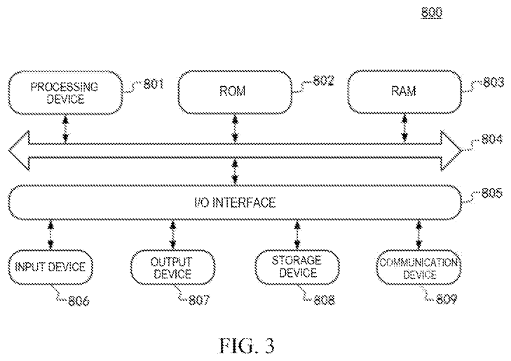

Referring now to FIG. 3, which shows a schematic structural diagram of an electronic device (e.g., an end point device or server) 800 suitable for implementing embodiments of the present disclosure. end point devices in embodiments of the present disclosure may include, but are not limited to, mobile end points such as mobile phones, laptops, digital broadcast receivers, PDAs (personal digital assistants), PADs (tablet computers), PMPs (portable multimedia players), car end points (e.g., car navigation end points), and the like, as well as fixed end points such as digital TVs, desktop computers, and the like. The electronic device shown in the figure is merely an example and should not bring any limitation to the functionality and scope of use of embodiments of the present disclosure.

Electronic device 800 may include a processing device (such as a Central Processor, graphics processing unit, etc.) 801, which can perform various appropriate actions and processes based on programs stored in read-only memory (ROM) 802 or loaded from storage device 808 into random access memory (RAM) 803. In RAM 803, various programs and data required for the operation of electronic device 800 are also stored. Processing devices 801, ROM 802, and RAM 803 are connected to each other through bus 804. Input/output (I/O) interface 805 is also connected to bus 804.

Typically, the following devices can be connected to the I/O interface 805: input device(s) 806, including touch screens, touchpads, keyboards, mice, cameras, microphones, accelerometers, gyroscopes, etc.; output device(s) 807, including liquid crystal displays (LCDs), speakers, vibrators, etc.; storage device(s) 808, including magnetic tapes, hard disks, etc.; and communication device(s) 809. Communication devices 809 can allow electronic devices 800 to communicate wirelessly or wirelessly with other devices to exchange data. Although electronic devices 800 with various devices are shown in the figure, it should be understood that it is not required to implement or have all of the devices shown. More or fewer devices can be implemented or provided instead.

In particular, according to embodiments of the present disclosure, the process described above with reference to the flowchart may be implemented as a computer software program. For example, embodiments of the present disclosure include a computer program product comprising a computer program carried on a computer-readable medium, the computer program comprising program code for performing the method shown in the flowchart. In such embodiments, the computer program may be downloaded and installed from the network through the communication device 809, or installed from the storage device 808, or installed from the ROM 802. When the computer program is executed by the processing device 801, the above-described functions defined in embodiments of the present disclosure are performed.

It should be noted that the computer-readable medium described above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device, or any combination thereof. More specific examples of computer-readable storage media can include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this disclosure, a computer-readable storage medium can be any tangible medium containing or storing a program that can be used by or in conjunction with an instruction execution system, device, or device. In this disclosure, a computer-readable signal medium can include a data signal propagated in a baseband or as part of a carrier wave, which carries computer-readable program code. Such propagated data signals can take many forms, including but not limited to electromagnetic signals, optical signals, or any suitable combination thereof. Computer-readable signal media can also be any computer-readable medium other than computer-readable storage media, which can send, propagate, or transmit programs for use by or in conjunction with instruction execution systems, devices, or devices. The program code contained on the computer-readable medium can be transmitted using any suitable medium, including but not limited to: wires, optical cables, RF (radio frequency), etc., or any suitable combination thereof.

In some embodiments, the client and server may communicate using any currently known or future developed network protocol such as HTTP (HyperText Transfer Protocol), and may be interconnected with any form or medium of digital data communication (e.g., a communication network). Examples of communication networks include local area networks (“LANs”), wide area networks (“WANs”), the Internet (e.g., the Internet), and end-to-end networks (e.g., ad hoc end-to-end networks), as well as any currently known or future developed networks.

The computer-readable medium can be included in the electronic device, or it can exist alone without being assembled into the electronic device.

The computer-readable medium carries one or more programs, and when the one or more programs are executed by the electronic device, the electronic device performs the method disclosed above.

Computer program code for performing the operations of the present disclosure may be written in one or more programming languages, or combinations thereof, including environment-oriented programming languages such as Java, Smalltalk, C++, and also conventional procedural programming languages such as “C” language or similar programming languages. The program code may be executed entirely on the user's computer, partially on the user's computer, as a standalone software package, partially on the user's computer, or entirely on a remote computer or server. In the case of a remote computer, the remote computer may be connected to the user's computer through any type of network, including a local area network (LAN) or a wide area network (WAN), or may be connected to an external computer (e.g., using an Internet service provider to connect via the Internet).

The flowcharts and block diagrams in the accompanying drawings illustrate the architecture, functions, and operations of systems, methods, and computer program products that may be implemented in accordance with various embodiments of the present disclosure. in this regard, each block in the flowchart or block diagram may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in reverse order, depending on the function involved. It should also be noted that each block in the block diagram and/or flowchart, and combinations of blocks in the block diagram and/or flowchart, may be implemented using a dedicated hardware-based system that performs the specified function or operation, or may be implemented using a combination of dedicated hardware and computer instructions.

Described in embodiments of the present disclosure relates to a unit may be implemented by way of software, may be implemented by way of hardware, wherein the name of the unit does not constitute a limitation on the unit itself in some cases.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system-on-chip (SOCs), complex programmable logic devices (CPLDs), and the like.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, there is provided a control method based on extended reality, comprising: obtaining a real environment image and a spatial positional relationship of a real environment, and mapping the real environment to an extended reality space based on the real environment image and the spatial positional relationship; setting a virtual light source in the extended reality space; and rendering a light effect for the real environment mapped to the extended reality space based on a light source parameter of the virtual light source, and displaying the rendered extended reality space.

According to one or more embodiments of the present disclosure, there is provided a control method based on extended reality, wherein before the rendering a light effect for the real environment mapped to the extended reality space based on a light source parameter of the virtual light source, the method further comprises: obtaining morphological data of an environmental object in the real environment, initial lighting for environment, and/or initial lighting for environmental object. The mapping the real environment to an extended reality space based on the spatial positional relationship comprises: mapping the real environment to the extended reality space based on one or more of the spatial positional relationship, the morphological data of the environmental object in the real environment, the initial lighting for environment, or the initial lighting for environmental object

According to one or more embodiments of the present disclosure, there is provided a control method based on extended reality, wherein after the mapping the real environment to an extended reality space based on the real environment image and the spatial positional relationship and before the rendering a light effect for the real environment mapped to the extended reality space based on a light source parameter of the virtual light source, the method further comprises: calibrating an optical property of an environmental object mapped to the extended reality space. The rendering a light effect for the real environment mapped to the extended reality space based on a light source parameter of the virtual light source comprises: rendering the light effect for the real environment mapped to the extended reality space based on the light source parameter and the optical property of the environmental object.

According to one or more embodiments of the present disclosure, there is provided a control method based on extended reality, wherein the rendering a light effect for the real environment mapped to the extended reality space based on a light source parameter of the virtual light source comprises: rendering a light effect for the real environment mapped to the extended reality space based on a light source parameter of the virtual light source and reference data. The reference data comprises one or more of: a spatial dimension of the real environment, a positional relationship of environmental objects in the real environment, a material of an environmental object in the real environment, or a user posture.

According to one or more embodiments of the present disclosure, there is provided a control method based on extended reality, wherein the light source parameter comprises one or more of the followings of the virtual light source: a light source position, a light source angle, a light source intensity, a hue, a focal length, a softness, and a shading degree.

According to one or more embodiments of the present disclosure, there is provided a control method based on extended reality, wherein before the rendering a light effect for the real environment mapped to the extended reality space based on a light source parameter of the virtual light source, the method further comprises: setting a virtual reflective object in the extended reality space. The rendering a light effect for the real environment mapped to the extended reality space based on a light source parameter of the virtual light source comprises: determining a reflection of the reflective object based on an optical property of the reflective object; and rendering the real environment image mapped to the extended reality space based on the virtual light source and the reflection of the reflective object.

According to one or more embodiments of the present disclosure, there is provided a control method based on extended reality, wherein the real environment comprises a photographic scene and a photographic object, and the virtual light source comprises a lighting source for the photographic object. Alternatively, the real environment comprises artwork, and the virtual light source comprises a light source of the artwork. Alternatively, the real environment comprises furniture, and the virtual light source comprises a lamp. Alternatively, the real environment comprises a real game scene, and the virtual light source comprises a virtual lighting prop.

According to one or more embodiments of the present disclosure, there is provided an extended reality-based control apparatus comprising: an obtaining unit configured to obtain a real environment image and a spatial positional relationship of a real environment; a processing unit configured to map the real environment to an extended reality space based on the real environment image and the spatial positional relationship; the processing unit is further configured to set a virtual light source in the extended reality space; the processing unit is further configured to render a light effect for the real environment mapped to the extended reality space based on a light source parameter of the virtual light source; and a display unit configured to display the rendered extended reality space.

According to one or more embodiments of the present disclosure, there is provided an electronic device comprising: at least one memory and at least one processor. The at least one memory is used to store program code, and the at least one processor is used to call the program code stored in the at least one memory to execute any of the methods described above.

According to one or more embodiments of the present disclosure, there is provided a computer-readable storage medium, the computer-readable storage medium for storing program code, the program code, when executed by a processor, causes the processor to perform the method described above.

According to one or more embodiments of the present disclosure, there is provided a computer program product, the computer program product comprising instructions that, when executed by a computer device causes the computer device to perform according to any one of the present disclosure method.

The above description is only the preferred embodiment of the present disclosure and an explanation of the technical principles used. Those skilled in the art should understand that the scope of the disclosure involved in this disclosure is not limited to the specific combination of the technical features of the above technical solutions, but should also cover other technical solutions formed by any combination of the above technical features or equivalent features without departing from the above disclosure concept. For example, the technical solutions formed by replacing the above features with (but not limited to) technical features with similar functions disclosed in this disclosure.

In addition, although the operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims.

I/We claim:

1. A control method based on extended reality, comprising:
obtaining a real environment image and a spatial positional relationship of a real environment, and mapping the real environment to an extended reality space based on the real environment image and the spatial positional relationship;
setting a virtual light source in the extended reality space; and
rendering a light effect for the real environment mapped to the extended reality space based on a light source parameter of the virtual light source, and displaying the rendered extended reality space.

2. The method of claim 1, wherein,
the method further comprises: obtaining morphological data of an environmental object in the real environment, initial lighting for environment, and/or initial lighting for environmental object.

3. The method of claim 2, wherein,
the mapping the real environment to an extended reality space based on the spatial positional relationship comprises: mapping the real environment to the extended reality space based on one or more of the spatial positional relationship, the morphological data of the environmental object in the real environment, the initial lighting for environment, or the initial lighting for environmental object.

4. The method of claim 1, wherein,
the method further comprises: calibrating an optical property of an environmental object mapped to the extended reality space.

5. The method of claim 4, wherein,
the rendering a light effect for the real environment mapped to the extended reality space based on a light source parameter of the virtual light source comprises: rendering the light effect for the real environment mapped to the extended reality space based on the light source parameter and the optical property of the environmental object.

6. The method of claim 1, wherein the rendering a light effect for the real environment mapped to the extended reality space based on a light source parameter of the virtual light source comprises:
rendering a light effect for the real environment mapped to the extended reality space based on a light source parameter of the virtual light source and reference data,
wherein the reference data comprises one or more of: a spatial dimension of the real environment, a positional relationship of environmental objects in the real environment, a material of an environmental object in the real environment, or a user posture.

7. The method of claim 1, wherein the light source parameter comprises one or more of the followings of the virtual light source: a light source position, a light source angle, a light source intensity, a hue, a focal length, a softness, and a shading degree.

8. The method of claim 1, wherein,
the method further comprises: setting a virtual reflective object in the extended reality space.

9. The method of claim of claim 8, wherein,
the rendering a light effect for the real environment mapped to the extended reality space based on a light source parameter of the virtual light source comprises:
determining a reflection of the reflective object based on an optical property of the reflective object; and
rendering the real environment image mapped to the extended reality space based on the virtual light source and the reflection of the reflective object.

10. The method of claim 1, wherein,
the real environment comprises a photographic scene and a photographic object, and the virtual light source comprises a lighting source for the photographic object.

11. The method of claim 1, wherein,
the real environment comprises artwork, and the virtual light source comprises a light source of the artwork.

12. The method of claim 1, wherein,
the real environment comprises furniture, and the virtual light source comprises a lamp.

13. The method of claim 1, wherein,
the real environment comprises a real game scene, and the virtual light source comprises a virtual lighting prop.

14. An electronic device comprising:
at least one memory and at least one processor;
wherein the at least one memory is configured to store program code, and the at least one processor is configured to call the program code stored in the at least one memory to execute a method comprising:
obtaining a real environment image and a spatial positional relationship of a real environment, and mapping the real environment to an extended reality space based on the real environment image and the spatial positional relationship;
setting a virtual light source in the extended reality space; and
rendering a light effect for the real environment mapped to the extended reality space based on a light source parameter of the virtual light source, and displaying the rendered extended reality space.

15. The electronic device of claim 14, wherein,
the method further comprises: obtaining morphological data of an environmental object in the real environment, initial lighting for environment, and/or initial lighting for environmental object.

16. The electronic device of claim 15, wherein,
the mapping the real environment to an extended reality space based on the spatial positional relationship comprises: mapping the real environment to the extended reality space based on one or more of the spatial positional relationship, the morphological data of the environmental object in the real environment, the initial lighting for environment, or the initial lighting for environmental object.

17. The electronic device of claim 14, wherein,
the method further comprises: calibrating an optical property of an environmental object mapped to the extended reality space.

18. The electronic device of claim 17, wherein,
the rendering a light effect for the real environment mapped to the extended reality space based on a light source parameter of the virtual light source comprises: rendering the light effect for the real environment mapped to the extended reality space based on the light source parameter and the optical property of the environmental object.

19. The electronic device of claim 14, wherein the rendering a light effect for the real environment mapped to the extended reality space based on a light source parameter of the virtual light source comprises:
rendering a light effect for the real environment mapped to the extended reality space based on a light source parameter of the virtual light source and reference data,
wherein the reference data comprises one or more of: a spatial dimension of the real environment, a positional relationship of environmental objects in the real environment, a material of an environmental object in the real environment, or a user posture.

20. A non-transitory computer-readable storage medium storing program code that, when executed by a processor, causes the processor to perform a method comprising:
obtaining a real environment image and a spatial positional relationship of a real environment, and mapping the real environment to an extended reality space based on the real environment image and the spatial positional relationship;
setting a virtual light source in the extended reality space; and
rendering a light effect for the real environment mapped to the extended reality space based on a light source parameter of the virtual light source, and displaying the rendered extended reality space.
